(19) United States
(12) Patent Application Publication
(10) Pub. No.: US 2026/0174074 A1
(43) Pub. Date: Jun. 25, 2026

(54) PLANT GROWTH SUPPRESSION METHOD AND PLANT GROWTH SUPPRESSION SYSTEM

(71) Applicant: SEIKO EPSON CORPORATION, Tokyo (JP)

(72) Inventors: Hirotsugu MARUYAMA, NAGANO-SHI (JP); Motoyoshi SUZUKI, AZUMINO-SHI (JP); Minoru MORIWAKI, MATSUMOTO-SHI (JP)

(21) Appl. No.: 19/431,237

(22) Filed: Dec. 23, 2025

(30) Foreign Application Priority Data
Dec. 25, 2024 (JP) 2024-229069

(51) Int. Cl. A01M 21/04

(52) U.S. Cl. CPC A01M 21/04

(57) ABSTRACT

The plant growth suppression method according to the present disclosure includes a step of, within a single day, irradiating a plant with suppression light including left circularly polarized light during a second time period that is different from a first time period during which the plant is irradiated with growth light. The photon flux density of the suppression light is a value below the light compensation point of the plant.

The present application is based on, and claims priority from JP Application Serial Number 2024-229069, filed Dec. 25, 2024, the disclosure of which is hereby incorporated by reference herein in its entirety.

### BACKGROUND

### 1. Technical Field

The present disclosure relates to a plant growth suppression method and a plant growth suppression system.

### 2. Related Art

As one of the methods for removing weeds, a method of spraying herbicide in a liquid or granular form on the land where weeds are growing is known in the related art. However, when herbicides are used, problems occur as described in “Assessment of overall herbicide effects on river ecosystems through periphyton and aquatic plants”, by Shigehisa Hatakeyama, published 2006 in the Japanese Journal of Environmental Toxicology, Volume 9, Number 2, pages 51 to 60.

As described in “Assessment of overall herbicide effects on river ecosystems through periphyton and aquatic plants”, when a herbicide is used, there is a concern that the influence on the environment such as rivers and soil and the ecosystem may increase.

### SUMMARY

In order to overcome the above problem, a plant growth suppression method according to one aspect of the present disclosure includes a step of irradiating a plant with suppression light including left circularly polarized light during a second time period that is different from a first time period during which the plant is irradiated with growth light within a single day, wherein a photon flux density of the suppression light is a value below the light compensation point of the plant.

A plant growth suppression system according to an aspect of the present disclosure includes a light source device configured to emit light; an illuminance uniformizing optical device configured to uniformize illuminance of the light emitted from the light source device; a projection optical device configured to adjust a size of an irradiated region of the light emitted from the illuminance uniformizing optical device; a polarization conversion device configured to convert the light emitted from the light source device into left circularly polarized light; and a control device configured to control an intensity of the light emitted from the light source device.

### BRIEF DESCRIPTION OF THE DRAWINGS

FIG. 1 is a photograph illustrating the initial morphology of a tomato plant of a first embodiment.

FIG. 2 is a photograph illustrating a state in which two types of circularly polarized light are irradiated on a tomato plant.

FIG. 3 is a photograph illustrating morphology of a right side stem before irradiation with right circularly polarized light.

FIG. 4 is a photograph illustrating morphology of a central stem before irradiation with right circularly polarized light and left circularly polarized light.

FIG. 5 is a photograph illustrating morphology of a left side stem before irradiation with left circularly polarized light.

FIG. 6 is a photograph illustrating morphology of the whole tomato plant after irradiation with each type of circularly polarized light.

FIG. 7 is a photograph illustrating morphology of the left side stem irradiated with left circularly polarized light on the same photography date as in FIG. 6.

FIG. 8 is a photograph illustrating morphology of the left side stem irradiated with left circularly polarized light on a photography date later than that of FIG. 7.

FIG. 9 is another photograph illustrating morphology of the left side stem irradiated with left circularly polarized light on the same photography date as in FIG. 8.

FIG. 10 is a photograph illustrating initial morphology of horsetail of the second embodiment.

FIG. 11 is a photograph illustrating a state in which left circularly polarized light is being irradiated on the horsetail.

FIG. 12 is a photograph illustrating the morphology of horsetail after irradiation with left circularly polarized light.

FIG. 13 is a photograph illustrating the morphology of horsetail in the next year after that of FIG. 12.

FIG. 14 is a photograph illustrating the morphology of horsetail on a photography date later than that of FIG. 13.

FIG. 15 is a photograph illustrating the ground surface of the land where the experiment of the third embodiment was conducted.

FIG. 16 is a photograph illustrating a state in which green foxtail is irradiated with left circularly polarized light.

FIG. 17 is a photograph illustrating morphology of green foxtail after irradiation with left circularly polarized light.

FIG. 18 is a photograph illustrating morphology of green foxtail on a photography date later than that of FIG. 17.

FIG. 19 is a photograph from another angle illustrating morphology of green foxtail on the same photography date as in FIG. 18.

FIG. 20 is a photograph illustrating morphology of green foxtail on a photography date later than that of FIG. 19.

FIG. 21 is a photograph illustrating morphology of green foxtail on a photography date later than that of FIG. 20.

FIG. 22 is a photograph illustrating morphology of sweet potato before start of an experiment in a fourth embodiment, which have not been irradiated with light.

FIG. 23 is a photograph illustrating morphology of sweet potato to be irradiated with right circularly polarized light before the start of the experiment.

FIG. 24 is a photograph illustrating morphology of sweet potato to be irradiated with left circularly polarized light before the start of the experiment.

FIG. 25 is a photograph illustrating morphology of sweet potato not irradiated with light after the start of the experiment.

FIG. 26 is a photograph illustrating morphology of sweet potato after irradiation with right circularly polarized light.

FIG. 27 is a photograph illustrating morphology of sweet potato after irradiation with left circularly polarized light.

FIG. 28 is a photograph comparing three types of sweet potato.

FIG. 29 is a schematic configuration diagram of a plant growth suppression system.

FIG. 30 is a diagram illustrating a spectrum of light emitted from the growth suppression system.

### DESCRIPTION OF EMBODIMENTS

### Plant Growth Suppression Method

Hereinafter, an example of the plant growth suppression method of the present embodiment will be described.

The plant growth suppression method of the present embodiment includes a step of, within a single day, irradiating a plant whose growth is to be suppressed with suppression light formed of weak left circularly polarized light during a predetermined time period in the night that is different from the daytime when the plant is irradiated with sunlight. Although details will be described later, the intensity of the suppression light is set to be sufficiently small. Specifically, when the intensity of the suppression light is expressed by photon flux density, the photon flux density of the suppression light is a value less than the light compensation point of the plant whose growth is to be inhibited. The left circularly polarized light is circularly polarized light in which the rotation direction of the polarization plane of light is counterclockwise when viewed from an observer located at a position facing the traveling direction of the light.

In the present specification, light necessary for growth of a plant is referred to as growth light, and light emitted for the purpose of suppressing growth of a plant is referred to as suppression light. Sunlight in the present embodiment corresponds to growth light in the scope of the claims. Therefore, in the present embodiment, the time period during which the plants are irradiated with sunlight during daytime corresponds to the first time period in the scope of the claims. The time period for which the plant is irradiated with the suppression light formed of left circularly polarized light corresponds to the second time period in the scope of the claims.

Photon flux density in the present specification means, to be precise, photosynthetic photon flux density. That is, photon flux density is one of indices of light intensity, and is represented by the number of photons in a waveband from 400 nm to 700 nm, which is effective for plant photosynthesis, among photons passing through a unit area in a unit of time. The unit of the photon flux density is, for example, μmol/m²/s. The light compensation point is a photon flux density at which the photosynthesis rate becomes zero, wherein the photosynthesis rate is the difference between the carbon dioxide absorption rate in photosynthesis and the carbon dioxide release rate in respiration. Therefore, when a plant is irradiated with light having a photon flux density exceeding the light compensation point, a photosynthetic reaction occurs in the plant. On the other hand, when a plant is irradiated with light having a photon flux density equal to or lower than the light compensation point, a photosynthetic reaction does not occur in the plant.

Three types of photoreceptors, phytochrome, cryptochrome, and phototropin, are known as plant photoreceptors. Phytochrome responds to red and far-red light, cryptochrome responds to blue light, and phototropin responds to blue light. Among these photoreceptors, phytochrome and phototropin are plant-specific photoreceptors. In view of the characteristics of the photoreceptors described above, it is desirable that the wavelength band of the suppression light includes blue wavelength band and the red wavelength band.

The photon flux density of the suppression light is preferably less than the light compensation point of the plant and also equal to or more than the minimum value that triggers a signal in the photoreceptor when the suppression light is irradiated. In order to exert a photosynthetic effect, light radiation on plants needs to be a radiation intensity of approximately 10 W/m² (photon flux density of approximately 40 μmol/m²/s) in natural daylight (approximately 6500K as the daylight radiation in daytime). In contrast to this, a radiation intensity that is significantly lower than the radiation intensity needed to exert a photosynthetic effect is sufficient for light radiation of plants to trigger a signal in the photoreceptors. In other words, the suppression light of the present embodiment is sufficient as long as it is a weak intensity that does not cause photosynthesis and also is an intensity sufficient to trigger a signal in the photoreceptor.

### First Embodiment

Hereinafter, a first embodiment of the present disclosure will be described.

In the first embodiment, a growth suppression experiment conducted by the present disclosing parties using tomato plants will be described.

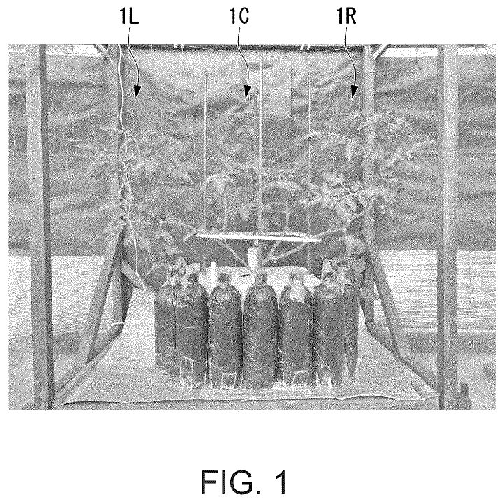

FIG. 1 is a photograph illustrating an initial state of a tomato plant.

As a sample used in this experiment, a tomato plant having a morphology in which three stems, 1L, 1C, and 1R, are branched from a single tomato plant was prepared as illustrated in FIG. 1. The tomatoes were cultivated in a planter, and the planter was placed outdoors and irradiated with sunlight in the daytime. By this, the tomato plant is growing smoothly. The photography date in FIG. 1 is Nov. 19, 2022.

In the present specification, daytime is defined as a time from sunrise to sunset within a single day, and is a synonym of possible sunshine duration in the scope of the claims. Sunlight in the present embodiment corresponds to growth light in the scope of the claims. Therefore, the time period during which the tomato plant is irradiated with sunlight in the daytime corresponds to the first time period in the scope of the claims.

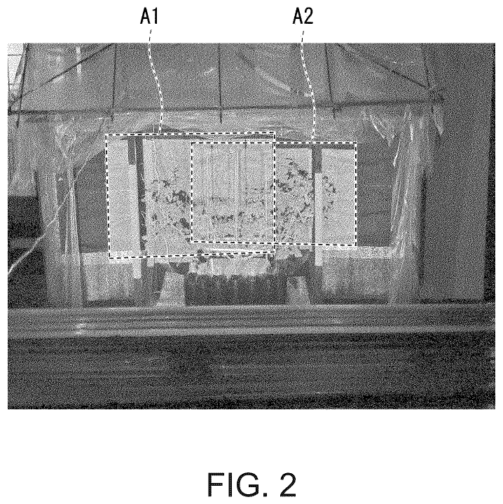

FIG. 2 is a photograph illustrating a state in which two types of illumination light are irradiated on the tomato plant.

Next, the tomato plants were irradiated with two types of circularly polarized light simultaneously for a certain period of time during the night. To be specific, as illustrated in FIG. 2, a region A1 including leaves attached to a left side stem 1L and leaves attached to a central stem 1C among three stems was irradiated with left circularly polarized light. In addition, a region A2 including leaves attached to the right side stem 1R and leaves attached to the central stem 1C was irradiated with right circularly polarized light. Therefore, the leaves attached to the central stem 1C are irradiated with both left circularly polarized light and right circularly polarized light.

As the irradiation condition of the illumination light, the irradiation time was set to 4 hours from 19 o' clock to 23 o' clock at night. The illumination period of the illumination light was set to every day for 27 days from Nov. 19, 2022 to Dec. 14, 2022. The photon flux density of left circularly polarized light and the photon flux density of right circularly polarized light were both about 3 μmol/m²/s. Therefore, the leaves attached to the right side stem 1R and the leaves attached to the left side stem 1L were irradiated with light of about 3 μmol/m²/s, and the leaves attached to the central stem 1C were irradiated with light of about 6 μmol/m2/s. The wavelength band of each type of circularly polarized light was a wavelength band including a red wavelength band and a blue wavelength band. The light compensation point of a tomato plant is about 50 μmol/m²/s.

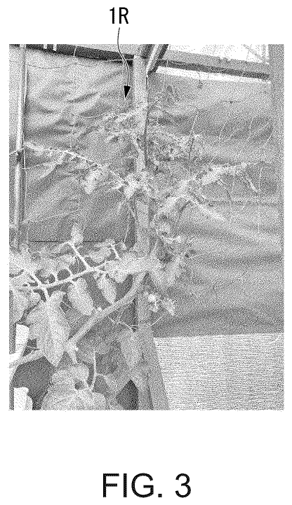

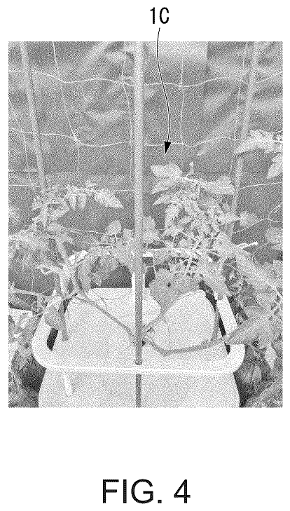

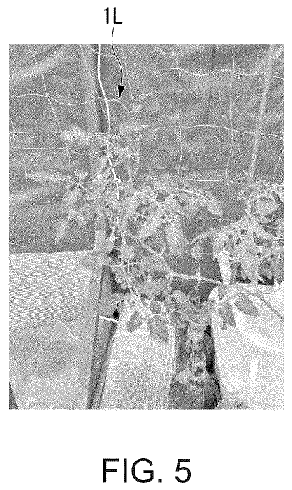

FIG. 3 is a photograph illustrating morphology of the right side stem 1R before irradiation with right circularly polarized light. FIG. 4 is a photograph illustrating morphology of the central stem 1C before irradiation with right circularly polarized light and left circularly polarized light. FIG. 5 is a photograph illustrating morphology of the left side stem 1L before irradiation with left circularly polarized light. The photography date of these images is Nov. 19, 2022.

As illustrated in FIGS. 3 to 5, before irradiation with each type of circularly polarized light, all of the three stems 1R, 1C, and 1L and the leaves attached to the stems grew normally, and no difference in growth state is recognizable.

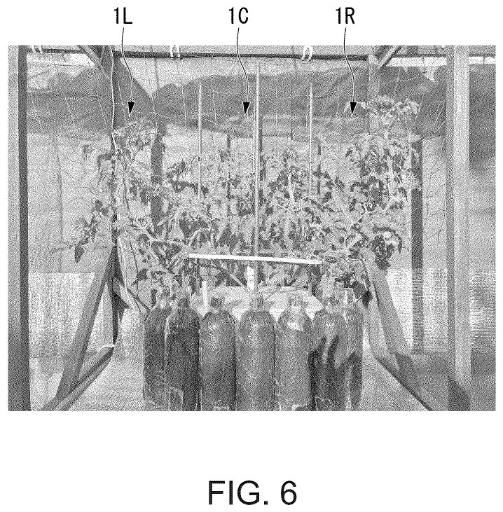

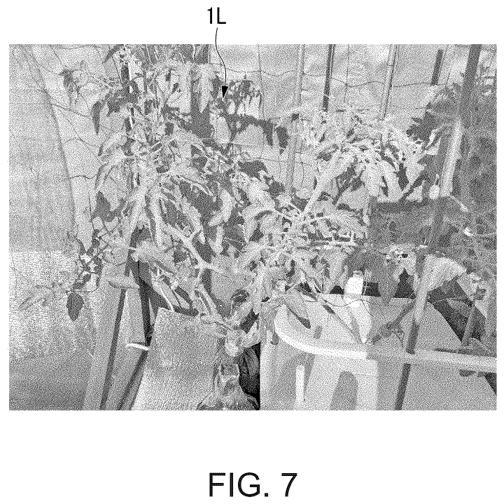

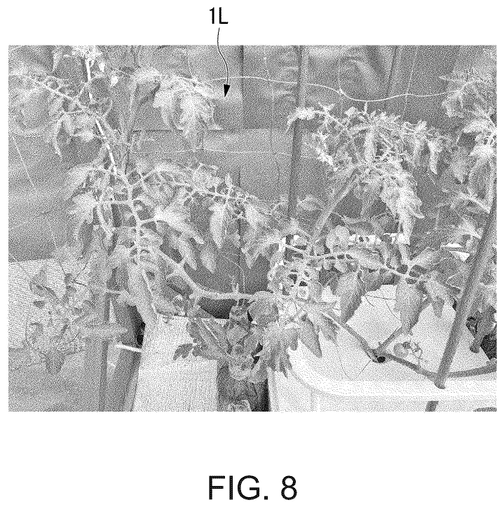

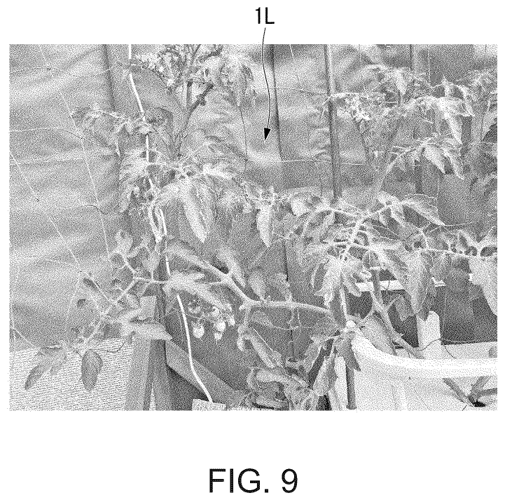

FIG. 6 is a photograph illustrating the entire tomato plant on the photography date after irradiation with each type of circularly polarized light for a certain period of time. FIG. 7 is a photograph illustrating the left side stem 1L irradiated with left circularly polarized light on the same day as the photograph of FIG. 6. The photography date in FIGS. 6 and 7 is Dec. 10, 2022. FIG. 8 is a photograph illustrating the left side stem 1L irradiated with left circularly polarized light on a photography date later than that of FIG. 7. FIG. 9 is a photograph taken from an angle different from that of FIG. 8. The photography date in FIGS. 8 and 9 is Dec. 14, 2022.

Although it is difficult to understand from the photograph illustrated in FIG. 6, the growth state of the leaves attached to the left side stem 1L, which were irradiated with left circularly polarized light, was worse than the growth state of the leaves attached to the right side stem 1R, which were irradiated with right circularly polarized light, and the growth state of the leaves attached to the central stem 1C, which were irradiated with both types of circularly polarized light. In particular, the leaves attached to the right side stem 1R and the central stem 1C are dark green in color and are turgid. On the other hand, the leaves attached to the left side stem 1L are yellowed and wilted as a whole as illustrated in FIG. 7. FIGS. 8 and 9 are photographs taken four days after the photography date in FIG. 7, and yellowing and wilting of the leaves are more remarkable.

### Discussion of First Embodiment

In this embodiment, since tomato plants having three stems branching from a single stem were used, there is no influence of individual differences of the stems on the experimental results. Nevertheless, it was found that the growth state of the stems and leaves irradiated with left circularly polarized light was inferior to the growth state of the other stems and leaves.

### Second Embodiment

Hereinafter, a second embodiment of the present disclosure will be described.

In the second embodiment, a growth suppression experiment conducted by the present disclosing parties using horsetail (Equisetum arvense) will be described.

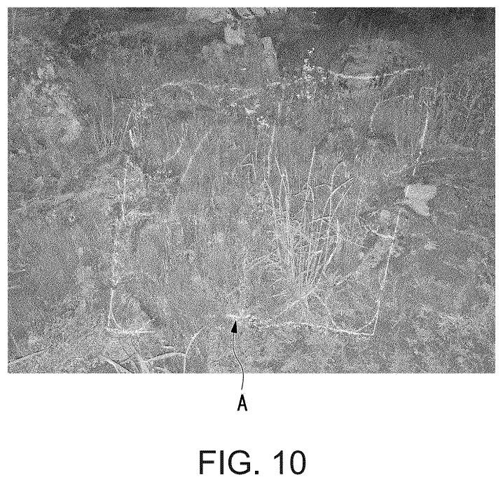

FIG. 10 is a photograph illustrating the initial state of horsetail.

The experiment was performed in a section of a garden with a good deal of horsetail, as illustrated in FIG. 10. A rectangular region indicated by a reference sign A is a region irradiated with left circularly polarized light. The photography date in FIG. 10 is May 16, 2023.

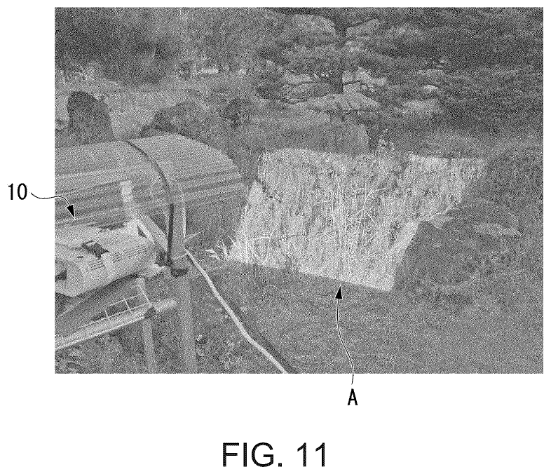

FIG. 11 is a photograph illustrating a state in which left circularly polarized light is being irradiated on the horsetail.

As illustrated in FIG. 11, the region A illustrated in FIG. 10 was irradiated with left circularly polarized light for a certain period of time during the night. As the irradiation condition of left circularly polarized light, the irradiation time was set to 4 hours from 19 o' clock to 23 o' clock at night. The irradiation period was every day for 22 days from May 16, 2023 to Jun. 6, 2023. The growth suppression system 10 installed at a predetermined height from the ground was used to irradiate the ground with left circularly polarized light obliquely downward. Therefore, in the rectangular region A, the light intensity at a position close to the growth suppression system 10 was relatively high, and the light intensity at a position far from the growth suppression system 10 was relatively low. In particular, the photon flux density of left circularly polarized light was about 18 μmol/m²/s at a location on the near side that is close to the growth suppression system 10, and about 5 μmol/m²/s at a location on the far side that is far from the growth suppression system 10. The wavelength band of left circularly polarized light was a wavelength band including a red wavelength band and a blue wavelength band.

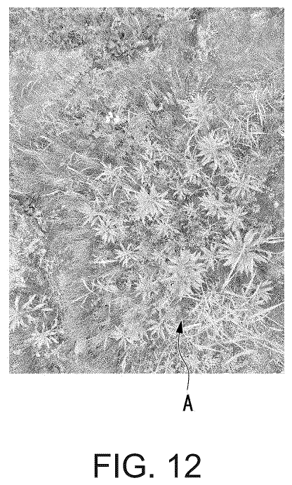

FIG. 12 is a photograph illustrating the state of horsetail on a photography date after 10 days from the start of the experiment. The photography date in FIG. 12 is May 25, 2023.

As illustrated in FIG. 12, horsetail continued to flourish, and the growth state of horsetail was almost the same as that at the start of the experiment. At this time, no inhibition of the growth of horsetail was observed, and therefore the experiment of irradiation with left circularly polarized light was once terminated.

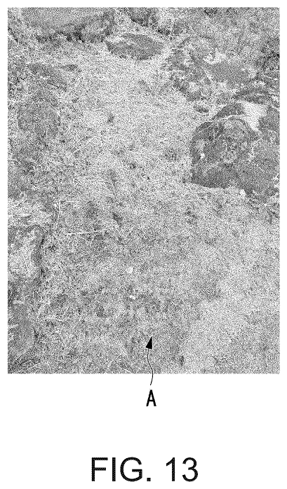

FIG. 13 is a photograph illustrating the state of horsetail on a photography date after about one year passed from the photography date of FIG. 12. The photography date in FIG. 13 is May 21, 2024.

The present disclosing parties observed again the region A where horsetail was irradiated with left circularly polarized light the previous year, and as a result, found that horsetail hardly germinated as illustrated in FIG. 13.

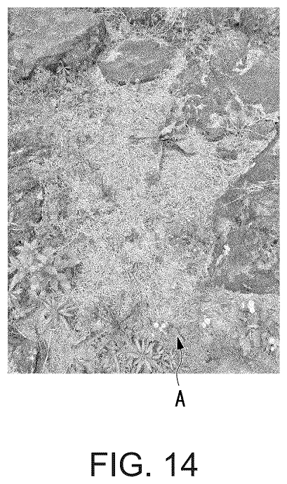

FIG. 14 is a photograph illustrating the state of horsetail on a photography date later than that of FIG. 13. The photography date in FIG. 14 is Jun. 10, 2024.

As illustrated in FIG. 14, it was found that the situation of the region A was not substantially changed even after about three weeks from the photography date in FIG. 13, and horsetail hardly germinated.

### Discussion of Second Embodiment

Horsetail is a perennial plant with rhizomes, nutrients obtained by photosynthesis accumulate in the rhizomes, and, after winter, horsetail germinates in the spring of the next year using nutrients stored in the rhizomes. In view of this characteristic, it is presumed that the reason why horsetail did not grow the year after the irradiation with left circularly polarized light is that some action was caused by the irradiation with left circularly polarized light and nutrients necessary for germination of horsetail the next year did not accumulate in the rhizomes. Generally, horsetail is said to be a weed that has a strong reproductive power and that is difficult to get rid of. However, it was found that the germination of horsetail in the next year can be suppressed by irradiating horsetail with left circularly polarized light as described above.

### Third Embodiment

A third embodiment of the present disclosure will be described below.

In the third embodiment, a growth suppression experiment conducted by the present disclosing parties using green foxtail (Setaria viridis) will be described.

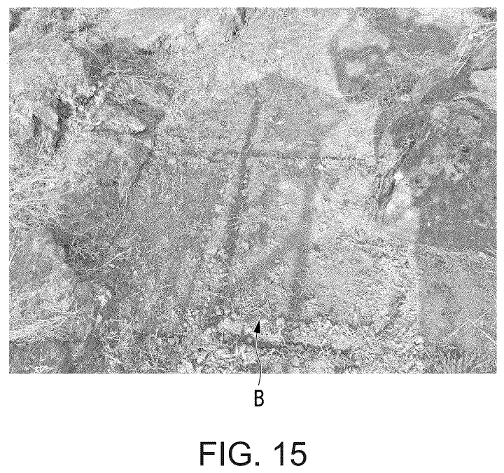

FIG. 15 is a photograph illustrating the ground of the garden where the experiment was conducted.

In the experiment, weeds were removed from a partial region of the garden to create a region B where, as illustrated in FIG. 15, no weeds were growing. The area of the region B to be tested is 1 m². The photography date in FIG. 15 is Jun. 8, 2023.

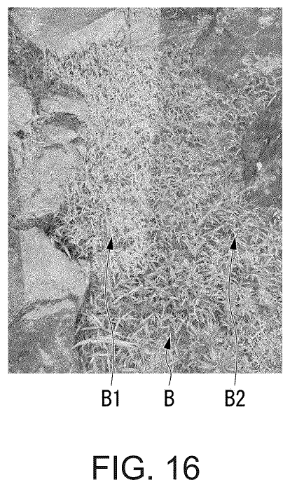

FIG. 16 is a photograph illustrating a state in which green foxtail is irradiated with left circularly polarized light.

As illustrated in FIG. 16, the region B, which is the target of the experiment, was divided into two regions, each of which was 0.5 m², and only a single region B1 was irradiated with left circularly polarized light for a certain period of time during the night. As the irradiation condition of left circularly polarized light, the irradiation time was set to 4 hours from 19 o' clock to 23 o' clock at night. The irradiation period was every day for two months from Jun. 7, 2023 to Aug. 7, 2023. As in the second embodiment, a growth suppression system was used to obliquely irradiate the ground with left circularly polarized light. The photon flux density of left circularly polarized light was about 18 μmol/m²/s at the front side close to the growth suppression system and about 5 μmol/m²/s at the back side far from the growth suppression system. The wavelength band of left circularly polarized light was a wavelength band including a red wavelength band and a blue wavelength band. In the following description, the region irradiated with left circularly polarized light is referred to as an irradiated region B1, and the region not irradiated with left circularly polarized light is referred to as a non-irradiated region B2.

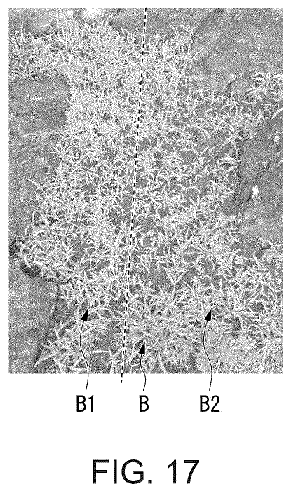

FIG. 17 is a photograph illustrating the appearance of green foxtail on the photography date, which was after 26 days elapsed from the start of the experiment. The photography date in FIG. 17 is Jul. 2, 2023.

As illustrated in FIG. 17, green foxtail started growing in the region B where no weeds were growing initially. However, at this time, it is still difficult to determine any difference in the growth state of the green foxtail between the irradiated region B1 and the non-irradiated region B2.

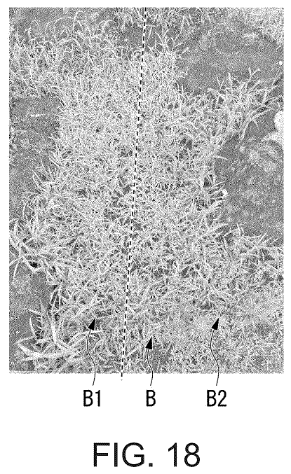

FIG. 18 is a photograph illustrating the state of green foxtail on a photography date after 10 days from the photography date of FIG. 17. The photography date in FIG. 18 is Jul. 12, 2023.

Although it is slightly difficult to understand in FIG. 18, at this time, a difference in the growth state of green foxtail was confirmed between the irradiated region B1 and the non-irradiated region B2.

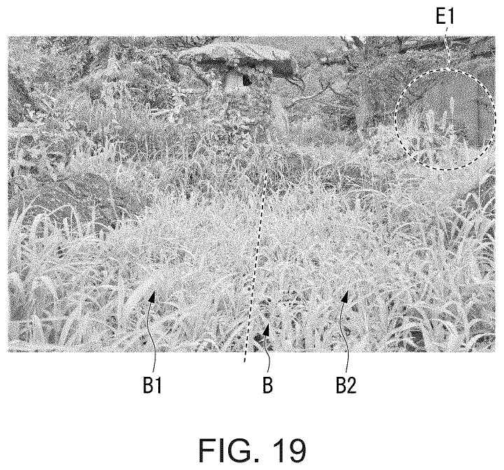

FIG. 19 is a photograph taken on the same day as the photography date of FIG. 18, and is a photograph taken from an angle closer to the ground than the photograph of FIG. 18.

As illustrated in FIG. 19, it was found that a plural green foxtail with flower spikes had appeared in the non-irradiated region B2 (photograph portion E1), whereas no green foxtail with flower spikes had appeared in the irradiated region B1.

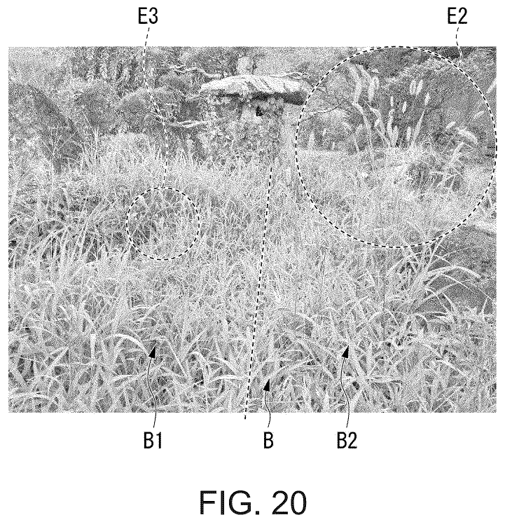

FIG. 20 is a photograph taken on Aug. 4, 2023, 24 days after the photography date in FIG. 19, and is a photograph taken from the same angle as the photograph in FIG. 19.

As illustrated in FIG. 20, it was found that the height of the green foxtail was higher as a whole in the non-irradiated region B2, and that green foxtail with flower spikes grew particularly large (photograph portion E2). On the other hand, in the irradiated region B1, the number of the green foxtail with flower spikes is very small (photograph portion E3), and it is determined that the height of the green foxtail is low as a whole.

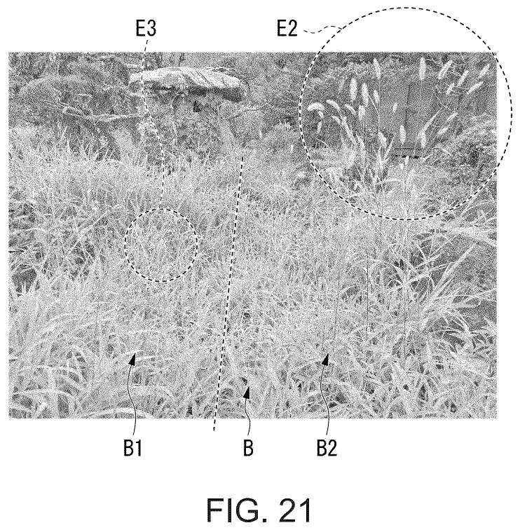

FIG. 21 is a photograph taken on Aug. 7, 2023, three days after the photography date in FIG. 20, and is a photograph taken from the same angle as the photograph in FIG. 20.

As illustrated in FIG. 21, the difference in the growth state of green foxtail between the non-irradiated region B2 and the irradiated region B1 is more remarkable.

### Discussion of Third Embodiment

Green foxtail is an annual plant that grows when seeds produced in the flower spikes fall on the ground, and is said to be a plant having strong reproductive capability. However, from the results of the present experiment, it was found that the growth of green foxtail can be suppressed by irradiating such green foxtail with left circularly polarized light. As a result of comparing the growth state of the green foxtail in the non-irradiated region B2 and in the irradiated region B1, the disclosing parties found that the mean value of the height of the green foxtail in the non-irradiated region B2 was about 70 to 80 cm, whereas the mean value of the height of the green foxtail in the irradiated region B1 was about 30 to 40 cm. In addition, the number of flower spikes was 34 per 0.5 m² in the non-irradiated region B2, whereas the number of spikes in the irradiated region B1 was 3 per 0.5 m². Thus, by reducing the number of flower spikes of green foxtail, the germination of green foxtail in the next season can be reduced.

### Fourth Embodiment

A fourth embodiment of the present disclosure will be described below.

In the fourth embodiment, a growth suppression experiment conducted by the present disclosing parties using sweet potato will be described.

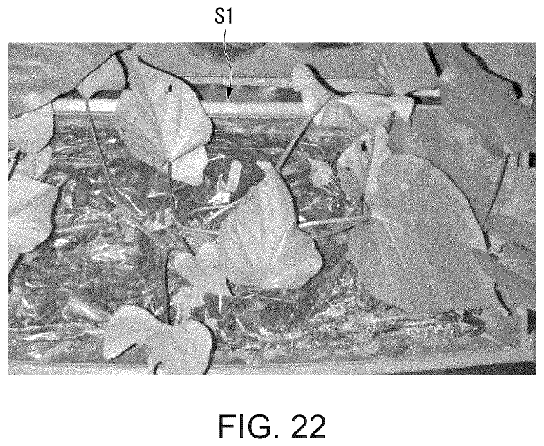

FIGS. 22 to 24 are photographs illustrating the initial state of sweet potato.

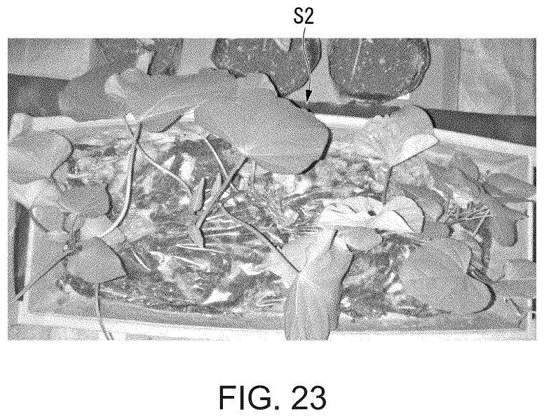

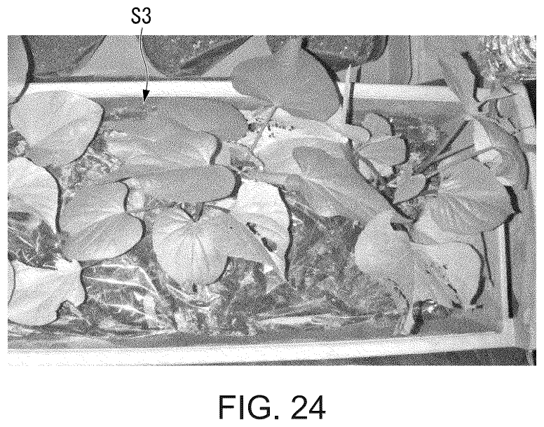

As illustrated in FIGS. 22 to 24, sweet potato cultivated in a planter was used as a sample for the experiment. In the daytime, the sweet potato was irradiated with sunlight and the sweet potato grew smoothly. The photography date in FIGS. 22 to 24 is Aug. 9, 2024. The sweet potato S1 in FIG. 22 was a sample that was not irradiated with any circularly polarized light. The sweet potato S2 in FIG. 23 was a sample irradiated with right circularly polarized light. The sweet potato S3 in FIG. 24 was a sample irradiated with left circularly polarized light.

Next, for a certain period of time during the night, the sweet potato S2 of FIG. 23 was irradiated with right circularly polarized light, and the sweet potato S3 of FIG. 24 was irradiated with left circularly polarized light. As the irradiation conditions of each type of circularly polarized light, the irradiation time was set to 4 hours from 19 o' clock to 23 o' clock at night. The irradiation period was every day for 38 days from Aug. 10, 2024 to Sep. 16, 2024. As for the intensity of each type of circularly polarized light, the photon flux density of right circularly polarized light was about 10 μmol/m²/s, and the photon flux density of left circularly polarized light was about 1 μmol/m²/s. The wavelength band of each type of circularly polarized light was a wavelength band including a red wavelength band and a blue wavelength band.

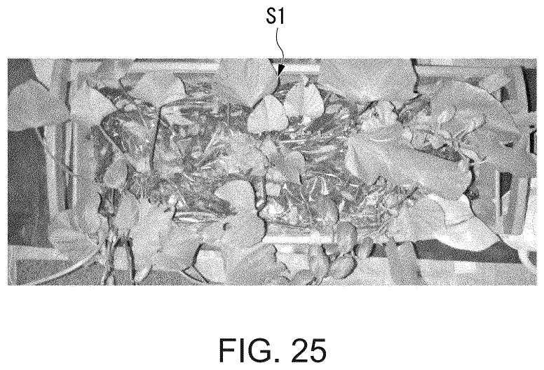

FIG. 25 is a photograph illustrating the state of the sweet potato S1 not irradiated with any circularly polarized light 30 days after the start of the test. The photography date in FIG. 25 is Sep. 8, 2024.

When FIG. 25 is compared with FIG. 22, it is found that the number of leaves increased and that the sweet potato S1 is growing smoothly.

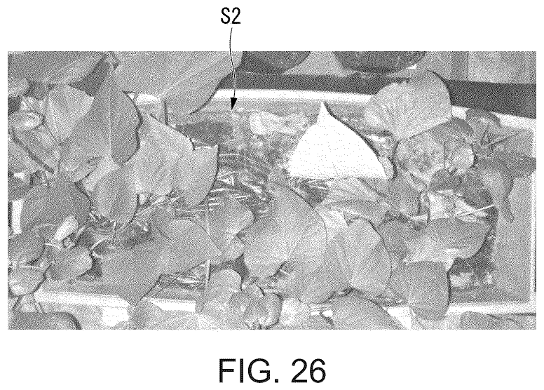

FIG. 26 is a photograph illustrating the state of the sweet potato S2 irradiated with right circularly polarized light 30 days after the start of the test. The photography date in FIG. 26 is Sep. 8, 2024.

When FIG. 26 is compared with FIG. 23, it is found that the number of leaves increased and that the sweet potato S2 is growing smoothly.

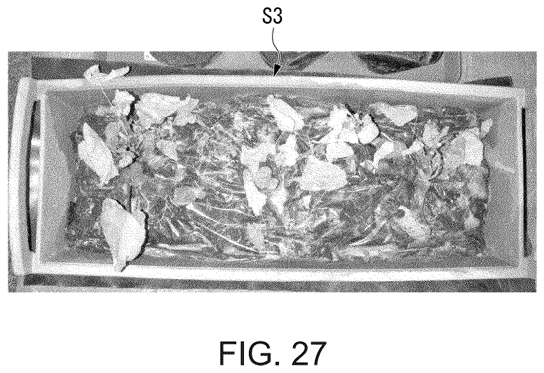

FIG. 27 is a photograph illustrating the state of the sweet potato S3 irradiated with left circularly polarized light 30 days after the start of the test. The photography date in FIG. 27 is Sep. 8, 2024.

As illustrated in FIG. 27, the state of the sweet potato S3 irradiated with left circularly polarized light was completely different from the state of the sweet potato S1 not irradiated with light illustrated in FIG. 25 and the state of the sweet potato S2 irradiated with right circularly polarized light illustrated in FIG. 26, and the sweet potato S3 irradiated with left circularly polarized light had withered.

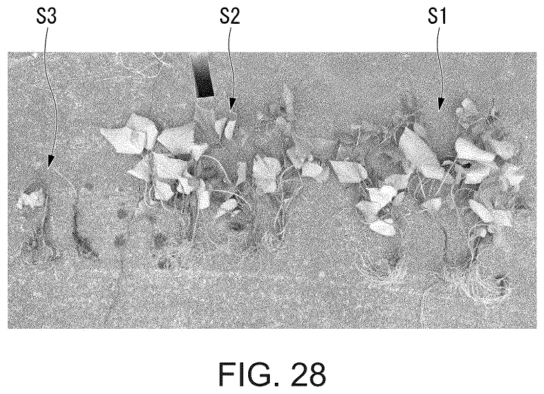

FIG. 28 is a photograph showing the state of the three types of sweet potato taken out from the planter. The photography date in FIG. 28 is Sep. 16, 2024.

As illustrated in FIG. 28, the sweet potato S1 not irradiated with circularly polarized light and the sweet potato S2 irradiated with right circularly polarized light grew normally, whereas the sweet potato S3 irradiated with left circularly polarized light had withered.

### Discussion of Fourth Embodiment

In this embodiment, the sweet potato irradiated with left circularly polarized light withered in about one month, unlike other sweet potatoes, and thus it was found that a large growth suppression effect was obtained.

### Summary of Embodiments

Through the above four embodiments, although the morphology and degree of change differ depending on the type of plant, the prospect of being able to suppress the growth of the plant by irradiating various plants with left circularly polarized light for a predetermined time at night was obtained. Therefore, this growth suppression method may be used for applications such as removing weeds, keeping plants short, and thinning out leaves and stems that are thick at high density. According to the present method, since a chemical such as a herbicide is not used, the burden on the environment and the ecosystem can be suppressed. In the present method, the intensity of left circularly polarized light may be low, and therefore, the energy required for carrying out the present method can be reduced. As in the above embodiment, when left circularly polarized light including a red wavelength band and a blue wavelength band, that is, left circularly polarized light of magenta color, is irradiated at night, there is a concern that it may annoy people living in the vicinity of the irradiated region. However, since the present method requires a sufficiently low light intensity, the influence on the people in the neighborhood can be suppressed to a low level.

### Plant Growth Suppression System

Hereinafter, an example of a plant growth suppression system of the present embodiment will be described.

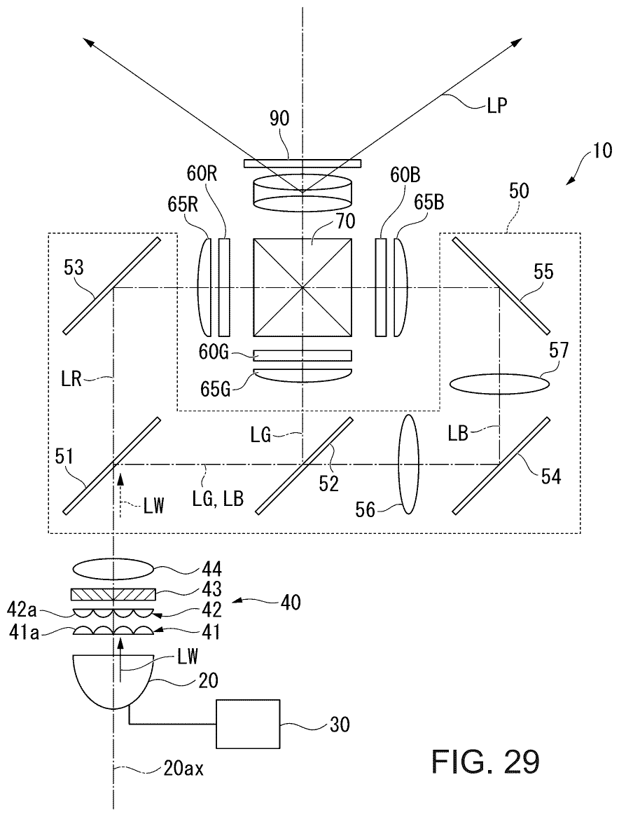

FIG. 29 is a schematic configuration diagram of the growth suppression system 10 of the present embodiment.

The growth suppression system 10 according to the present embodiment includes, as illustrated in FIG. 29, a light source device 20, a control device 30, an illuminance uniformizing optical device 40, a color separation optical device 50, a light modulation device 60R, a light modulation device 60G, a light modulation device 60B, a light combining optical device 70, a projection optical device 80, and a polarization conversion device 90.

The light source device 20 is formed of a high-pressure mercury lamp that emits white light LW. The light source device 20 may be formed of, for example, a light emitting diode, a laser diode, a phosphor that emits fluorescence by irradiation with excitation light, or the like, instead of the ultra-high pressure mercury lamp. It is desirable that the light source device 20 emits light including at least a blue light component and a red light component.

The control device 30 controls the intensity of the white light LW emitted from the light source device 20 to be less than the light compensation point of the plant whose growth is to be suppressed. The control device 30 is constituted by a CPU built in the system.

The illuminance uniformizing optical device 40 uniformizes the illuminance of the white light LW emitted from the light source device 20 in an irradiated region. The illuminance uniformizing optical device 40 includes a first lens array 41, a second lens array 42, a polarization conversion element 43, and a superimposing lens 44. Since the growth suppression system 10 includes the illuminance uniformizing optical device 40, illuminance unevenness in the light irradiated region can be reduced, and a uniform growth suppression effect can be obtained.

The first lens array 41 includes a plurality of first lenses 41a for dividing the white color light LW emitted from the light source device 20 into a plurality of partial light fluxes. The plurality of first lenses 41a are arranged in a matrix in a plane perpendicular to an illumination optical axis 20ax. Note that the central axis of the white light LW emitted from the light source device 20 is defined as the illumination optical axis 20ax.

The second lens array 42 includes a plurality of second lenses 42a corresponding to the plurality of first lenses 41a of the first lens array 41. The second lenses 42a are arranged in a matrix in a plane perpendicular to the illumination optical axis 20ax. Together with the superimposing lens 44, the second lens array 42 forms images of the first lenses 41a of the first lens array 41 in the vicinity of the light modulation device 60R, of the light modulation device 60G, and of the light modulation device 60B.

The polarization conversion element 43 converts the white light LW emitted from the second lens array 42 into linearly polarized light having a predetermined polarization direction. The polarization conversion element 43 includes a polarization separation film and a retardation film (not illustrated).

The superimposing lens 44 collects the light fluxes that exited from the polarization conversion element 43 and superimposes the light fluxes on one another in the vicinity of the light modulation device 60R, of the light modulation device 60G, and of the light modulation device 60B.

The color separation optical device 50 separates the white light LW emitted from the light source device 20 into red light LR, green light LG, and blue light LB. The color separation optical device 50 includes a first dichroic mirror 51, a second dichroic mirror 52, a first reflective mirror 53, a second reflective mirror 54, a third reflective mirror 55, a first relay lens 56, and a second relay lens 57.

The first dichroic mirror 51 transmits red light LR and reflects light including green light LG and blue light LB. By this, the first dichroic mirror 51 thus separates the white light LW outputted from the light source device 20 into red light LR and light containing green light LG and blue light LB. The second dichroic mirror 52 reflects the green light LG and transmits the blue light LB. By this, the second dichroic mirror 52 thus separates the light containing the green light LG and the blue light LB outputted from the first dichroic mirror 51 into the green light LG and the blue light LB.

The first reflective mirror 53 is disposed in the optical path of the red color light LR, and reflects the red color light LR transmitted through the first dichroic mirror 51 toward the light modulation device 60R. The second reflective mirror 54 and the third reflective mirror 55 are disposed in the optical path of the blue light LB and guide the blue light LB having passed through the second dichroic mirror 52 toward the light modulation device 60B. The green light LG is reflected off the second dichroic mirror 52 toward the light modulation device 60G.

The first relay lens 56 is disposed between the second dichroic mirror 52 and the second reflective mirror 54 in the optical path of the blue light LB. The second relay lens 57 is disposed between the second reflective mirror 54 and the third reflective mirror 55 in the optical path of the blue light LB. The first relay lens 56 and the second relay lens 57 compensate for the light loss of the blue light LB caused by the fact that the optical path length of the blue light LB is longer than the optical path length of the red light LR or the green light LG.

The light modulation device 60R modulates the red color light LR. The light modulation device 60G modulates the green light LG. The light modulation device 60B modulates the blue light LB. Transmissive liquid crystal panels, for example, are used as the light modulation device 60R, the light modulation device 60G, and the light modulation device 60B. A polarization plate (not illustrated) is disposed on both the incident side and the emission side of each liquid crystal panel.

A field lens 65R is disposed on the incident side of the light modulation device 60R. The field lens 65R parallelizes the red color light LR incident on the light modulation device 60R. A field lens 65G is disposed on the incident side of the light modulation device 60G. The field lens 65G parallelizes the green light LG incident on the light modulation device 60G. A field lens 65B is disposed on the incident side of the light modulation device 60B. The field lens 65B parallelizes the blue light LB incident on the light modulation device 60B.

The color light flux outputted from the light modulation device 60R, the light modulation device 60G, and the light modulation device 60B enter the light combining optical device 70. The combining optical device 70 combines the red light LR, the green light LG, and the blue light LB with one another and outputs the combined light toward the projection optical device 80. A cross dichroic prism is used as the combining optical device 70.

The projection optical device 80 has a plurality of projection lenses. The projection optical device 80 enlarges and irradiates the combined light emitted from the light combining optical device 70 toward the irradiated region. The projection optical device 80 may have a zoom function. By this, it is possible to adjust the size of the light irradiated region.

The polarization conversion device 90 is provided on the light exiting side of the projection optical device 80. The polarization conversion device 90 converts the linearly polarized light emitted from the projection optical device 80 into left circularly polarized light LP. The polarization conversion device 90 is formed of a quarter-wave plate. The slow axis or the fast axis of the quarter-wave plate is disposed so as to form an angle of 45 degrees with respect to the polarization axis of the linearly polarized light emitted from the projection optical device 80.

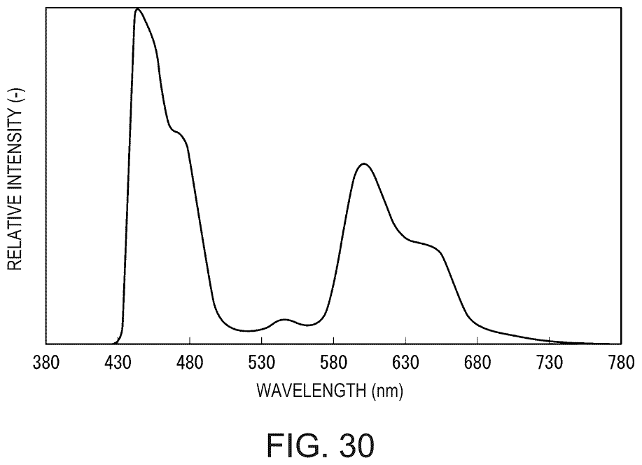

FIG. 30 is a diagram illustrating the spectrum of left circularly polarized light LP emitted from the growth suppression system 10.

As illustrated in FIG. 30, the left circularly polarized light LP includes blue light components having peaks at wavelengths 450 nm and yellow to red light components having peaks at wavelengths 600 nm, and hardly includes green light components. The waveband of left circularly polarized light LP can be adjusted by controlling the light transmission amounts of the light modulation device 400R, the light modulation device 400G, and the light modulation device 400B.

According to the growth suppression system 10 of the present embodiment, it is possible to efficiently suppress the growth of a plant present in an arbitrary place.

The technical scope of the present disclosure is not limited to the above-described embodiments, and various modifications can be made without departing from the spirit of the present disclosure.

For example, in the embodiment of the growth suppression method described above, sunlight that is naturally applied to plants in daytime is used as the growth light, but instead of this configuration, artificial illumination light such as that used in plant factories may be used as the growth light. In the case where illumination light is used as growth light, the time for which suppression light is emitted is not necessarily nighttime, and may be any time different from the time for which growth light is emitted.

In the embodiment of the growth suppression system described above, the growth suppression system includes the color separation optical device, the three light modulation devices, and the combining optical device, but does not necessarily have to include these components, and may instead be configured to cause the light outputted from the illuminance uniformizing optical device to directly enter the projection optical device. The growth suppression system may include a light source device including a red LED, a blue LED, and a dichroic mirror that combines the red light and the blue light. According to this configuration, by turning on one of the red LED and the blue LED and turning off the other, it is possible to emit only one of the light beams.

In addition, specific numerical values such as the irradiation time of the suppression light and the photon flux density described in the above embodiment are merely examples, and can be changed as appropriate.

### SUMMARY OF THE PRESENT DISCLOSURE

Hereinafter, a summary of the present disclosure will be supplemented.

### Supplementary Note 1

A plant growth suppression method includes a step of irradiating a plant with suppression light including left circularly polarized light during a second time period that is different from a first time period during which the plant is irradiated with growth light within a single day, wherein a photon flux density of the suppression light is a value below the light compensation point of the plant.

According to the configuration of supplementary note 1, it is possible to provide a plant growth suppression method with a small load on the environment and the ecosystem while reducing energy required for performing the method.

### Supplementary Note 2

The plant growth suppression method according to supplementary note 2, wherein the first time period is a time within a possible sunshine duration and the second time period is a time outside the possible sunshine duration.

According to the plant growth suppression method of supplementary note 2, sunlight can be used as growth light, and the suppression light may be emitted at night.

### Supplementary Note 3

The plant growth suppression method according to supplementary note 1 or supplementary note 2, wherein the second time period is 4 hours or more.

According to the configuration of supplementary note 3, it is possible to reliably suppress the growth of the plant.

### Supplementary Note 4

The plant growth suppression method according to any one of supplementary note 1 to supplementary note 3, wherein the photon flux density is 3 μmol/m²/s or more.

According to the configuration of supplementary note 4, it is possible to reliably suppress the growth of the plant.

### Supplementary Note 5

The plant growth suppression method according to supplementary note 4, wherein the photon flux density is 15 μmol/m²/s or more.

According to the configuration of supplementary note 5, it is possible to more reliably suppress the growth of the plant.

### Supplementary Note 6

The plant growth suppression method according to any one of supplementary note 1 to supplementary note 5, wherein in the step, the suppression light is applied to a part of the plant containing chlorophyll.

According to the configuration of supplementary note 6, since the photoreceptor of the plant can detect the irradiation of the suppression light, the growth of the plant can be effectively suppressed.

### Supplementary Note 7

The plant growth suppression method according to any one of supplementary note 1 to supplementary note 6, wherein photon flux density of the suppression light is equal to or higher than a minimum value that triggers a signal in a photoreceptor of the plant when the suppression light is irradiated.

According to the configuration of supplementary note 7, the photoreceptor can detect the irradiation of the suppression light as a signal, and thus the growth of the plant can be reliably suppressed.

### Supplementary Note 8

The plant growth suppression method according to any one of supplementary note 1 to supplementary note 7, wherein the wavelength band of the suppression light includes a blue wavelength band and a red wavelength band.

According to the configuration of supplementary note 8, it is possible to reliably suppress the growth of the plant using at least the light in the wavelength band necessary for growth suppression.

### Supplementary Note 9

A plant growth suppression system includes a light source device configured to emit light; an illuminance uniformizing optical device configured to uniformize illuminance of the light emitted from the light source device; a projection optical device configured to adjust a size of an irradiated region of the light emitted from the illuminance uniformizing optical device; a polarization conversion device configured to convert the light emitted from the light source device into left circularly polarized light; and a control device configured to control a light amount of light emitted from the light source device.

According to the configuration of supplementary note 9, it is possible to provide a plant growth suppression system with a small load on the environment and the ecosystem while reducing energy consumption.

What is claimed is:

1. A plant growth suppression method comprising:
a step of irradiating a plant with suppression light including left circularly polarized light during a second time period that is different from a first time period during which the plant is irradiated with growth light within a single day, wherein
a photon flux density of the suppression light is a value below the light compensation point of the plant.

2. The plant growth suppression method according to claim 1, wherein
the first time period is a time within a possible sunshine duration and
the second time period is a time outside the possible sunshine duration.

3. The plant growth suppression method according to claim 1, wherein
the second time period is 4 hours or more.

4. The plant growth suppression method according to claim 1, wherein
the photon flux density is 3 μmol/m²/s or more.

5. The plant growth suppression method according to claim 4, wherein
the photon flux density is 15 μmol/m²/s or more.

6. The plant growth suppression method according to claim 1, wherein
in the step, the suppression light is applied to a part of the plant containing chlorophyll.

7. The plant growth suppression method according to claim 1, wherein
photon flux density of the suppression light is equal to or higher than a minimum value that triggers a signal in a photoreceptor of the plant when the suppression light is irradiated.

8. The plant growth suppression method according to claim 1, wherein
wavelength band of the suppression light includes a blue wavelength band and a red wavelength band.

9. A plant growth suppression system comprising:
a light source device configured to emit light;
an illuminance uniformizing optical device configured to uniformize illuminance of the light emitted from the light source device;
a projection optical device configured to adjust a size of an irradiated region of the light emitted from the illuminance uniformizing optical device;
a polarization conversion device configured to convert the light emitted from the light source device into left circularly polarized light; and
a control device configured to control an intensity of the light emitted from the light source device.
